(19) United States
(12) Patent Application Publication
(10) Pub. No.: US 2012/0043895 A1
(43) Pub. Date: Feb. 23, 2012

(54) LED BACKLIGHT MODULE

(75) Inventors: Meihao Wu, Guangdong (CN); Chiayin Hung, Guangdong (CN)

(73) Assignee: SHENZHEN CHINA STAR OPTOELECTRONICS TECHNOLOGY CO., LTD., Shenzhen (CN)

(21) Appl. No.: 12/997,699

(22) PCT Filed: Oct. 11, 2010
(86) PCT No.: PCT/CN10/77660

§ 371 Date: Dec. 13, 2010

(30) Foreign Application Priority Data
Aug. 20, 2010 (CN) 201010261527.1

(51) Int. Cl. H05B 37/02

(52) U.S. Cl. 315/192

(57) ABSTRACT

The present invention discloses a LED backlight module, used for a liquid crystal display apparatus. The LED backlight module comprises a plurality of location areas and a plurality of lighting string sets. The location areas correspond to a plurality of display areas of the liquid crystal display apparatus respectively. Each location area comprises a plurality of sub location areas corresponding to a portion of the display areas respectively. Each lighting string set comprises a plurality of LEDs, which is electrically connected in series, wherein the LEDs of each lighting string set are located in sub location areas in different location areas, respectively. Meanwhile, the sub location areas for locating the LEDs of each lighting string set are not adjacent. Accordingly, the present invention can prevent the whole LED backlight module scrapped due to few LED failure, and therefore, to raise the manufacture yield of the LED backlight module.

### BACKGROUND OF THE INVENTION

1. Field of the Invention

The present invention generally relates to a LED backlight module, and more particularly to a LED backlight module capable of preventing the whole LED backlight module scrapped due to a few LED failure, and therefore, to raise the manufacture yield of the LED backlight module.

2. Description of Prior Art

Nowadays, a liquid crystal display (LCD) is mainly manufactured by producing a backlight module first constructed by a backlight source, a plastic frame and a diffusion plate, and then assembling the backlight module with a liquid crystal front panel and a front frame to construct a LCD module for manufacturing a final product. Generally, the backlight module which the backlight sources of the liquid crystal display utilizes Cold Cathode Fluorescent Lamps (CCFL) is now substantially replaced by a LED backlight module because the properties of the low power consumption and mercury free of the LED backlight module. Consequently, the CCFL backlight module will be history ultimately. The LED backlight module will certainly replace the CCFL backlight modules overall.

The assembly method of the LED backlight module is generally utilize a plurality of LEDs, and numbers of LEDs are electrically connected in series as a lighting string set. According to the size of the LCD, a plurality of lighting string sets is arranged averagely. Each of the lighting string sets is driven with the DC voltage generated by the converter to drive the LEDs for lighting and replacing the CCFL as being the backlight source of the backlight module of the LCD.

Please refer to FIG. 1 and FIG. 2. FIG. 1 shows a diagram of the arrangement of the LEDs and the circuit in a LED backlight module according to prior art. FIG. 2 shows a diagram of that the illumination of the area 202 becomes darkened due to one LED failure in the LED backlight module 200 according to prior art. A side light type LED backlight module with three lighting string sets is illustrated. However, the number of the lighting string sets can be decided according to the size of the LCD. As shown in FIG. 1 and FIG. 2, the LED backlight module comprises three lighting string sets. Each of LEDs is indicated by the resistance thereof. One lighting string set comprises LEDs 10, 20, 30 in series. One lighting string set comprises LEDs 40, 50, 60 in series. One lighting string set comprises LEDs 70, 80, 90 in series. All the LEDs 10, 20, 30, 40, 50, 60, 70, 80, 90 are driven for lighting with the voltage and current generated by the drive circuit 100.

As shown in FIG. 2, the lighting string set comprising the LEDs 10, 20, 30 is used for lighting the display area corresponding to the area 202 of the LED backlight module 200; the lighting string set comprising the LEDs 40, 50, 60 is used for lighting the display area corresponding to the area 204 of the LED backlight module 200; the lighting string set comprising the LEDs 70, 80, 90 is used for lighting the display area corresponding to the area 206 of the LED backlight module 200. Because the LEDs in the same lighting string set are electrically connected in series, therefore, the whole LEDs 10, 20, 30 of the lighting string set will turn out when the LED 20 fails and the LED backlight module 200 becomes darkened in the area 202 as shown in FIG. 2. Similarly, in a case that the LED 60 fails, the LEDs 40, 50, 60 will turn out and the LED backlight module 200 becomes darkened in the area 204; in a case that the LED 90 fails, the LEDs 70, 80, 90 will turn out and the LED backlight module 200 becomes darkened in the area 206. Same problem also occurs in the direct type LED backlight module. Accordingly, failure of any LEDs will lead to an obvious brightness drop in a mass area of the display. An adverse effect is induced to the user obviously and the whole backlight module has to be scrapped and replaced.

Consequently, there is a need to provide a LED backlight module to solve the existing issues of prior art.

### SUMMARY OF THE INVENTION

An objective of the present invention is to provide a LED backlight module for preventing the whole LED backlight module scrapped due to a few LED failure, and therefore, to raise the manufacture yield of the LED backlight module and effectively decrease the cost.

For realizing the aforesaid objective of the present invention, the present invention provides a LED backlight module used for a liquid crystal display apparatus, comprising a LED drive circuit, generating at least one driving voltage needed for the LED backlight module; a plurality of location areas, corresponding to a plurality of display areas of the liquid crystal display apparatus, and each of the plurality of location areas comprises a plurality of sub location areas corresponding to a portion of the display areas, respectively; a first lighting string set, comprising a plurality of first LEDs, located in the sub location areas of the location areas, respectively, and the plurality of first LEDs is electrically connected to the LED drive circuit in series and driven by the at least one driving voltage for lighting, wherein the sub location areas for respectively locating the plurality of first LEDs are not adjacent; a second lighting string set, comprising a plurality of second LEDs, located in the sub location areas of the location areas, respectively, and the plurality of second LEDs is electrically connected to the LED drive circuit in series and driven by the at least one driving voltage for lighting, wherein the sub location areas for respectively locating the plurality of second LEDs are not adjacent; and a third lighting string set, comprising a plurality of third LEDs, located in the sub location areas of the location areas, respectively, and the plurality of third LEDs is electrically connected to the LED drive circuit in series and driven by the at least one driving voltage for lighting, wherein the sub location areas for respectively locating the plurality of third LEDs are not adjacent.

In the LED backlight module of the present invention, the plurality of location areas comprises a plurality of sub location areas respectively. The plurality of LEDs of each of the lighting string sets is located in sub location areas of the different location areas, respectively, wherein the sub location areas for respectively locating the plurality of LEDs of each of the lighting string sets are not adjacent.

The LED backlight module of the present invention can comprise a LED drive circuit, generating at least one driving voltage for driving the plurality of LEDs for lighting. Alternatively, the LED drive circuit can generate respective driving voltages for the lighting string sets to drive the lighting string sets for lighting respectively as being a backlight source of the LED backlight module.

The LED backlight module can be a direct light type LED backlight module.

The LED backlight module can be a side light type LED backlight module.

The LED can generate respective driving voltages for the first lighting string set, the second lighting string set and the third lighting string set, to drive the first lighting string set, the second lighting string set and the third lighting string set for lighting, respectively.

The LED backlight module provided by the present invention can comprise a LED drive circuit, generating at least one driving voltage for driving the plurality of LEDs for lighting. Alternatively, the LED drive circuit can generate respective driving voltages for the lighting string sets, to drive the lighting string sets for lighting respectively as being a backlight source of the LED backlight module.

The LED backlight module provided by the present invention can be a direct light type LED backlight module or a side light type LED backlight module.

According to the present invention, the whole LED backlight module can be prevented to be scrapped due to a few LED failure, and therefore, to raise the manufacture yield of the LED backlight module.

### BRIEF DESCRIPTION OF THE DRAWINGS

FIG. 1 shows a diagram of the arrangement of the LEDs and the circuit in a LED backlight module according to prior art;

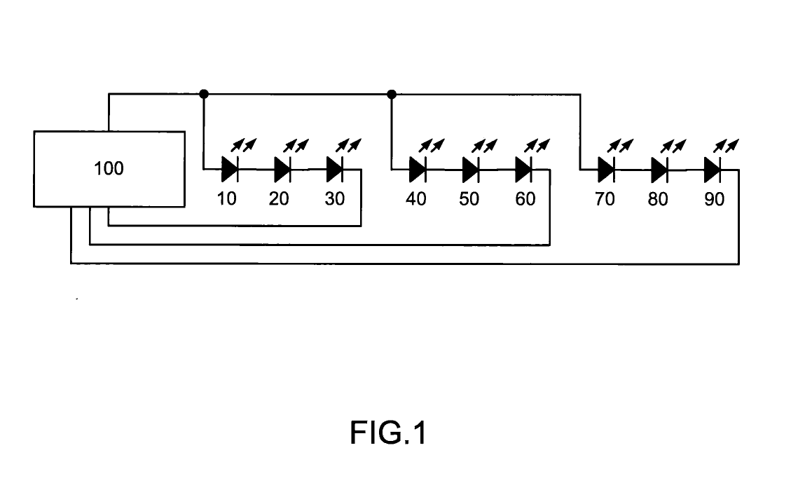

FIG. 2 shows a diagram of that the illumination of the display area becomes darkened due to one LED failure in the LED backlight module according to prior art;

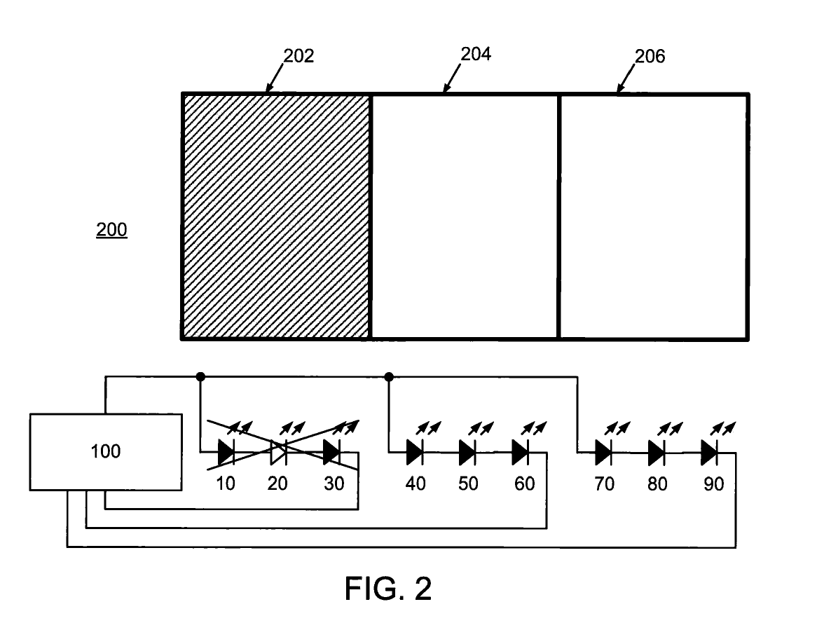

FIG. 3 shows a diagram of the arrangement of the LEDs and the circuit in a LED backlight module according to the present invention;

FIG. 4 shows a diagram of that the illumination of the display area becomes darkened due to one LED failure in the LED backlight module according to the present invention.

### DETAILED DESCRIPTION OF THE INVENTION

For a better understanding the aforementioned content of the present invention, preferable embodiments are illustrated in accordance with the attached figures for further explanation:

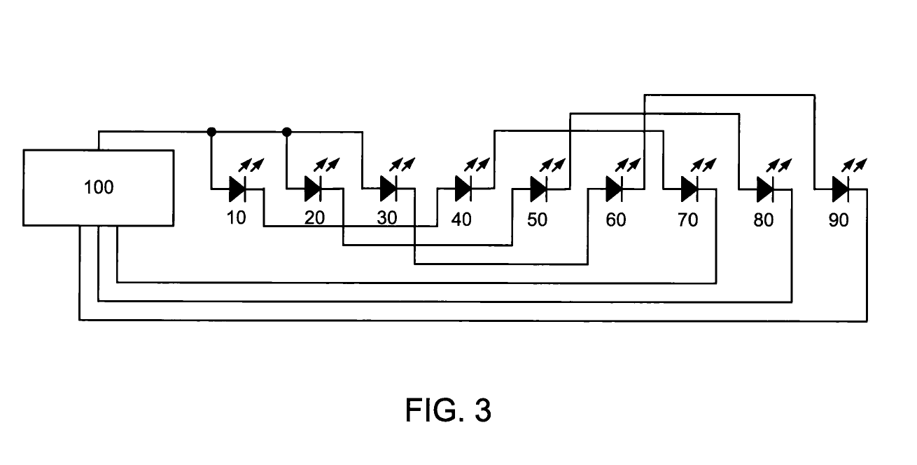

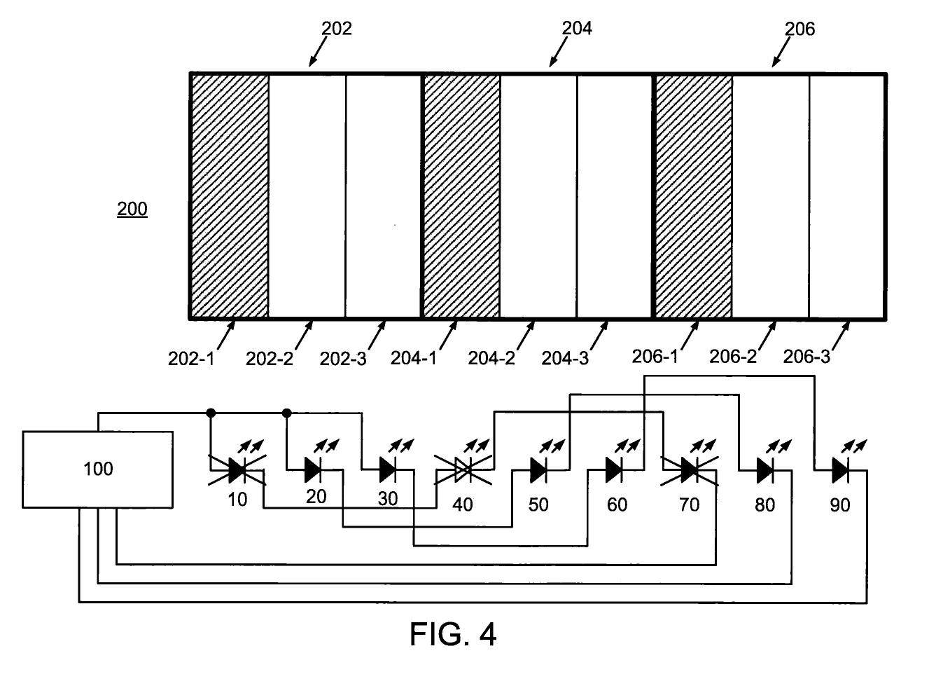

Please refer to FIG. 3 and FIG. 4. FIG. 3 shows a diagram of the arrangement of the LEDs and the circuit in a LED backlight module according to the present invention. FIG. 4 shows a diagram of that the illumination of the display area becomes darkened due to one LED failure in the LED backlight module according to the present invention.

In this embodiment of the present invention, a side light type LED backlight module with three lighting string sets is illustrated. However, the number of the lighting string sets can be decided according to the size of the LCD in a practical situation. The aforementioned situation is merely for the convenient explanation for the present invention but not the limitation thereto. Please refer to FIG. 3 and FIG. 4. The LED backlight module 200 comprises a LED drive circuit 100, a first location area 202, a second location area 204, a third location area 206 and a first lighting string set, a second lighting string set, a third lighting string set as being the backlight source of the LED backlight module 200.

The LED drive circuit 100 is used for generating at least one driving voltage for the LEDs for lighting. The first location area 202 corresponds to the first display area of the liquid crystal display apparatus using the LED backlight module 200 of the present invention. The second location area 204 corresponds to the second display area of the liquid crystal display apparatus using the LED backlight module 200 of the present invention. The third location area 206 corresponds to the third display area of the liquid crystal display apparatus using the LED backlight module 200 of the present invention.

In FIG. 3 and FIG. 4, each of LEDs is indicated by the standard resistance symbol in the circuit design diagram. As shown in figures, the black resistance symbol represents a normal LED. The unpainted resistance symbol represents a failed LED. The resistance symbols marked with X represents that the LEDs have become darkened. The first lighting string set comprises first LEDs 10, 40, 70 in series; the second lighting string set comprises second LEDs 20, 50, 80 in series; the third lighting string set comprises third LEDs 30, 60, 90 in series. As shown in FIG. 4, the first LED 10 of the first lighting string set is located in the sub location area 202-1 of the first location area 202, so as to illuminate a portion of the first corresponding display area. The first LED 40 of the first lighting string set is located in the sub location area 204-1 of the second location area 204, so as to illuminate a portion of the corresponding second display area. The first LED 70 of the first lighting string set is located in the sub location area 206-1 of the third location area 206, so as to illuminate a portion of the corresponding third display area. The first LEDs 10, 40, 70 are electrically connected to the LED drive circuit 100 in series. The present invention utilizes the driving voltage generated by the LED drive circuit 100 to drive the first LEDs 10, 40, 70 for lighting, so as to illuminate a portion of the corresponding first display area, a portion of the corresponding second display area and a portion of the corresponding third display area, respectively.

As shown in FIG. 4, the second LED 20 of the second lighting string set is located in the sub location area 202-2 of the first location area 202, so as to illuminate a portion of the corresponding first display area. The second LED 50 of the second lighting string set is located in the sub location area 204-2 of the second location area 204, so as to illuminate a portion of the corresponding second display area. The second LED 80 of the second lighting string set is located in the sub location area 206-2 of the third location area 206, so as to illuminate a portion of the corresponding third display area. The first LEDs 20, 50, 80 are electrically connected to the LED drive circuit 100 in series. The present invention utilizes the driving voltage generated by the LED drive circuit 100 to drive the second LEDs 20, 50, 80 for lighting, so as to illuminate a portion of the corresponding first display area, a portion of the corresponding second display area and a portion of the corresponding third display area, respectively.

As shown in FIG. 4, the third LED 30 of the third lighting string set is located in the sub location area 202-3 of the first location area 202, so as to illuminate a portion of the corresponding first display area. The third LED 60 of the second lighting string set is located in the sub location area 204-3 of the second location area 204, so as to illuminate a portion of the corresponding second display area. The third LED 90 of the third lighting string set is located in the sub location area 206-3 of the third location area 206, so as to illuminate a portion of the corresponding third display area. The third LEDs 30, 60, 90 are electrically connected to the LED drive circuit 100 in series. The present invention utilizes the driving voltage generated by the LED drive circuit 100 to drive the third LEDs 30, 60, 90 for lighting, so as to illuminate a portion of the corresponding first display area, a portion of the corresponding second display area and a portion of the corresponding third display area, respectively.

Meanwhile, as shown in FIG. 4, in a case that the LED 40 fails, the first LEDs 10, 70 also fail at the same time because the first LEDs 10, 40, 70 are electrically connected in series. Therefore, the sub location areas 202-1, 204-1, 206-1 become darkened and leads to that the illuminations of the portions of the corresponding first, second, third display areas become darkened. The LEDs 10, 40, 70 in series are dispersed and located in different sub location areas 202-1, 204-1, 206-1 in the present invention. Therefore, when one of the LEDs fails, this merely results in that the whole brightness of the LED backlight module 200 is reduced uniformly, so as to prevent the problem of the obvious brightness drop in a mass area of the display. The above-mentioned problem caused in prior art obviously gives an adverse effect to the user. Hereby, the situation of scrapping and replacing the whole backlight module can be prevented.

Furthermore, in the aforesaid embodiment of the present invention, a side light type LED backlight module with three lighting string sets is illustrated. Yet, the present invention also can be applied for a direct light type LED backlight module. Moreover, the LED driving circuit 100 can generate respective driving voltages for the first lighting string set, the second lighting string set and the third lighting string set. Hereby, the first LEDs 10, 40, 70 of the first lighting string set, the second LEDs 20, 50, 80 of the second lighting string set and the third LEDs 30, 60, 90 of the third lighting string set can be driven for lighting respectively. Besides, in FIG. 4 of the present invention, an arrangement of the sub location areas in the location areas is in sequence for illustration to explain the concept of the present invention, but not the limited thereto. Only if the obvious brightness drop in a mass area of the display caused in prior art can be prevented, other arrangements also can be used for replacing the arrangement that each sub location area in the respective location areas corresponds one lighting string set in the present invention. As long as the respective sub location areas for locating the plurality of the first LEDs, the plurality of the second LEDs, or the plurality of the third LEDs are not adjacent and the obvious brightness drop in a mass area of the display does not occur.

In a word, The LED backlight module provide by the present invention can minimize the effect of the few failed LEDs on the whole LED backlight module, and the adverse vision effect caused by the failed LEDs can be controlled to be reduced in an acceptable range for the user. Accordingly, the issue of scrapping and replacing the whole backlight module due to the few LED failure can be prevented. The manufacture yield of the LED backlight module can be raised and the cost can be effectively decreased.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A LED backlight module, used for a liquid crystal display apparatus, characterized in that the LED backlight module comprises:
a LED drive circuit, generating at least one driving voltage needed for the LED backlight module;
a plurality of location areas, corresponding to a plurality of display areas of the liquid crystal display apparatus, and each of the plurality of location areas comprises a plurality of sub location areas corresponding to a portion of the display areas, respectively;
a first lighting string set, comprising a plurality of first LEDs, located in the sub location areas of the location areas, respectively, and the plurality of first LEDs is electrically connected to the LED drive circuit in series and driven by the at least one driving voltage for lighting, wherein the sub location areas for respectively locating the plurality of first LEDs are not adjacent;
a second lighting string set, comprising a plurality of second LEDs, located in the sub location areas of the location areas, respectively, and the plurality of second LEDs is electrically connected to the LED drive circuit in series and driven by the at least one driving voltage for lighting, wherein the sub location areas for respectively locating the plurality of second LEDs are not adjacent; and
a third lighting string set, comprising a plurality of third LEDs, located in the sub location areas of the location areas, respectively, and the plurality of third LEDs is electrically connected to the LED drive circuit in series and driven by the at least one driving voltage for lighting, wherein the sub location areas for respectively locating the plurality of third LEDs are not adjacent.

2. The LED backlight module of claim 1, characterized in that the LED backlight module is a direct light type LED backlight module.

3. The LED backlight module of claim 1, characterized in that the LED backlight module is a side light type LED backlight module.

4. The LED backlight module of claim 1, characterized in that the plurality of first LEDs, the plurality of second LEDs and the plurality of third LEDs are utilized as a backlight source of the LED backlight module.

5. The LED backlight module of claim 1, characterized in that the LED drive circuit generates respective driving voltages for the first lighting string set, the second lighting string set and the third lighting string set, to drive the first lighting string set, the second lighting string set and the third lighting string set for lighting respectively.

6. A LED backlight module, used for a liquid crystal display apparatus, characterized in that the backlight module comprises:
a plurality of location areas, corresponding to a plurality of display areas of the liquid crystal display apparatus respectively; and
a plurality of lighting string sets, each of the lighting string sets comprising a plurality of LEDs, and the plurality of LEDs of each of the lighting string sets is electrically connected in series, wherein the plurality of LEDs of each of the lighting string sets is located in different location areas, respectively.

7. The LED backlight module of claim 6, characterized in that the plurality of location areas comprises a plurality of sub location areas respectively, and the plurality of LEDs of each of the lighting string sets is located in the sub location areas of the different location areas respectively, wherein the sub location areas for respectively locating the plurality of LEDs of each of the lighting string sets are not adjacent.

8. The LED backlight module of claim 6, characterized in further comprising a LED drive circuit, generating at least one driving voltage to drive the plurality of LEDs for lighting.

9. The LED backlight module of claim 8, characterized in that the LED drive circuit generates respective driving voltages for the plurality of lighting string sets, to drive the plurality of LEDs of the plurality of lighting string sets for lighting respectively.

10. The LED backlight module of claim 6, characterized in that the LED backlight module is a direct light type LED backlight module.

11. The LED backlight module of claim 6, characterized in that the LED backlight module is a side light type LED backlight module.

12. The LED backlight module of claim 6, characterized in that the plurality of LEDs located in the LED backlight module is utilized as a backlight source of the LED backlight module.

13. A LED backlight module, used for a liquid crystal display apparatus comprising a plurality of display areas, characterized in that the backlight module comprises:
a plurality of location areas, corresponding to a plurality of display areas of the liquid crystal display apparatus respectively, and each of the location areas comprises a plurality of sub location areas respectively; and
a plurality of lighting string sets, each of the lighting string sets comprising a plurality of LEDs, and the plurality of LEDs of each of the lighting string sets is located in one of the sub location areas of the different location areas, respectively, wherein the plurality of sub location areas for locating the plurality of LEDs of each of the lighting string sets have at least one other sub location area located therebetween.

14. The LED backlight module of claim 13, characterized in that the plurality of LEDs of each of the lighting string sets is electrically connected in series.

15. The LED backlight module of claim 14, characterized in further comprising a plurality of LED drive circuit, generating a plurality of driving voltages respectively corresponding to the plurality of lighting string sets, to drive the plurality of LEDs of the lighting string sets for lighting respectively.

16. The LED backlight module of claim 13, characterized in that the plurality of lighting string sets located in the LED backlight module is utilized as a backlight source of the LED backlight module.

17. The LED backlight module of claim 13, characterized in that the LED backlight module is a direct light type LED backlight module.

18. The LED backlight module of claim 13, characterized in that the LED backlight module is a side light type LED backlight module.
